(19) United States
(12) Patent Application Publication
(10) Pub. No.: US 2006/0167771 A1
(43) Pub. Date: Jul. 27, 2006

(54) Financial event software engine

(76) Inventor: Robert Allen Meldahl, Basking Ridge, NJ (US)

Correspondence Address: Robert Meldahl, 15 Hancock Court, Basking Ridge, NJ, 07920, US

(21) Appl. No.: 11/042,841

(22) Filed: Jan. 25, 2005

(51) Int. Cl. G07F 19/00; G07B 17/00

(52) U.S. Cl. 705/30

(57) ABSTRACT

A Software Engine that allows users to record accounting transactions in a double-entry bookkeeping system, without knowing which accounts to debit and credit. Each practical debit/credit combination is summarized by a single Financial Event Type. The potential for thousands of these Financial Event Types is made manageable by the Software Engine's organizing them into a hierarchical tree, allowing them to be grouped according to the company's business practice. The Financial Event Types and the hierarchical tree can be defined by the user.

### CROSS-REFERENCE TO RELATED APPLICATIONS

Not Applicable.

### FEDERALLY SPONSORED RESEARCH

Not Applicable.

### SEQUENCE LISTING OR PROGRAMS

Not Applicable.

### BACKGROUND OF THE INVENTION —FIELD OF THE INVENTION

The present invention relates to computer based accounting systems; and more particularly to a computer process that allows the user to enter transactions with a computer based accounting system without having to know which ledger account to debit and which one to credit, enabling the user to journal a transaction by just understanding the category of financial event that it is.

### BACKGROUND OF THE INVENTION—PRIOR ART

The German poet Johann Wolfgang Von Goethe once said that “Double-entry bookkeeping is one of the most beautiful discoveries of the human spirit.” It truly is a very powerful way of organizing information from a large number of financial transactions in a way that checks and tests the information by requiring that the “books” always remain in balance. A balance is maintained in the accounts because each transaction must both debit and credit the books an equal amount, leaving the total amount of all debits and all credits within the entire system to remain equal to each other at all times. However, this safety and elegance comes at a cost. The user who must record the transactions must know what accounts need to be debited and which ones need to be credited by each type of transaction that can occur to the business.

The bookkeeper's burden of knowing the relationship of each transaction to which accounts that are affected by it can become an overwhelming challenge when some companies have accounts that number in the hundreds. In the case where a company uses three-hundred ledger accounts, the number of possible transaction types, based just on the different possible combinations of ledger accounts that are debited and credited, can approach 90,000 (actually, the number would be 300×299=89,700, where each account can be combined with any other account except itself). In reality, this number is perhaps much smaller because most combinations would make no practical sense (i.e. a transaction that debits the Utilities expense account would not credit the Office Rent expense account or any other expense account). However, the number of practical combinations of accounts to be credited and debited could easily exceed one thousand and each one of these combinations requires that the user understand the debit and credit effects it will have on the accounts. The understanding of the company's bookkeeping system must be both intensive and extensive for an accountant to be able to record financial transactions with accuracy and efficiency.

There is a need to make the job of finding the debit/credit combinations for transactions easier for the trained bookkeeper and, hopefully, even usable by employees who are not skilled in the accounting arts. The present invention does this by making the debit/credit combinations into a single, easy to find and use, composite object that provides an intuitive description of a classification of financial transactions and performs the debit and credit update operations for the user. Furthermore, through its use of a hierarchical tree data structure that provides semantic information to the user, it makes the selection of a relevant debit/credit combination easy and intuitive.

U.S. Pat. No. 6,275,813 to George B. Berka, entitled Method and device for posting financial transactions in computerized accounting systems, hereinafter referred to as the Berka invention, discloses a method and device for posting financial transactions in a computerized accounting system. The transcription software records actual transactions as transfers of money between two of five accounting categories including income (I), expenses (E), assets (A), liabilities (L) and capital (C). The directional graphic character “<” visually indicates the direction of transfer between a user-input source and a destination category, always pointing at the destination category, thus assisting the user in posting the actual transactions with the destination as debit category and source as credit category. The general ledger may be user created or automatically posted by the computer. A plurality of account titles are assigned to each of the four basic categories (I, E, A, L), and each title includes a numeric identifier and a descriptive name. The first digit in the identifier denotes a category and the remaining digits denote an account number and the transaction is stored as a decimal record in a journal entry comprising the amount and the numeric identifier. The disclosed method and device is an accounting program that merely aids the user, or at best creates a general ledger.

The Berka invention attempts to make the debit/credit relationship of accounts more intuitive to the unskilled user by substituting a direction symbol (“<”) for the underlying debit/credit labeling that describes the effects of a transaction upon a business. This direction symbol has a source and destination which correspond to the credit and debit assignments of traditional accounting. With the Berka invention, the user is still required to know which specific ledger accounts are to be affected by the transaction and the particular effect that the transaction has on the accounts. With the present invention, however, the user is not required to have any knowledge whatsoever about the ledger accounts. With the present invention, the user only needs to know a small subset of the types of financial events that the company becomes involved in - the conversion of a type of event to the effects on the ledger accounts is performed by the invention itself, requiring no knowledge of accounting by the user.

U.S. Pat. No. 6,330,545 to Won-Kyo Suh, entitled Activity information accounting method and system, hereinafter referred to as the Suh invention, discloses activity information accounting method and system. The activity information accounting system stores an account title table corresponding to activity information, and performs accounting procedures on the basis of input activity information and an account title corresponding to the input activity information. The accounting system displays activity types including purchase and acquisition activity, sales and revenue activity, expenditure activity, investment and finance activity, and production activity. If a user selects one of the displayed activity types, the accounting system displays a screen for the user to input activity information for the selected activity type. The accounting system determines if the input activity information is internal activity or external activity, performs accounting procedures on the basis of determined result and the account title table. The accounting method and system enables those not trained in the field of accounting to be able to prepare accounting reports by simply inputting business activity information. The accounting reports prepared include balance sheets, income statements, cash flow statements and other accounting reports that provide different measures of overall company worth and performance, without having to undergo the complicated process of making journal entries.

The Suh invention does not perform the operation of maintaining a double-entry bookkeeping system as the present invention does. It records activity types, and, from these activity types, it generates various financial reports. Unlike Suh, the present invention supports the traditional model of accounting, where each transaction causes an equal debit and credit effect upon ledger accounts. The present invention, like Suh, allows the user to remain ignorant of debits and credits, but, unlike Suh, translates the user's knowledge about a transaction into the debit and credit updates that Goethe was so enamored with.

The difference between Suh and the present invention cannot be overstated. Suh avoids the complexity of double-entry bookkeeping by avoiding it and finding a substitute for it: the present invention, on the other hand, actually performs the complexity of double-entry bookkeeping for the user. For the first time in accounting history, the present invention provides a means of automating the debit and credit process, making it available to the unskilled user by automating the parts of the operation that are too complex for him to do directly. Unlike Suh, the present invention allows the user to do double-entry bookkeeping rather than avoiding it altogether.

The present invention, unlike any prior art or the obvious extensions of prior art, is the solution to the problem of how to make journaling of double-entry accounting accessible to the non-specialist. With the present invention, financial transactions can, for the first time, be properly recorded by the person who performs the transaction rather than the expert who knows how to debit and credit the transaction.

### BACKGROUND OF THE INVENTION—OBJECTS AND ADVANTAGES

The present invention incorporates the combination of a ledger account to be debited and a ledger account to be credited into a single composite object, referred to hereinafter as a Financial Event Type. The present invention is a software tool that creates, organizes, and uses these Financial Event Types in order to enter financial transactions into an accounting journal. This software tool is referred to hereinafter as the Financial Event Software Engine, or simply as the “Software Engine.”

Accordingly, besides the objects and advantages of the Financial Event Software Engine described in this patent application, several objects and advantages of the present invention are:
a) The Financial Event Types eliminate the need for the user to know what ledger account gets debited and which account gets credited by a given financial transaction. Each Event Type maintains a mapping to the ledger account that is to be debited by a event of its type and a mapping to the ledger account that is to be credit by it. The type of the transaction actually determines the debit/credit effects of the transaction.
b) The large number of possible Financial Event Types is broken down into a hierarchical tree, known as a Financial Event Tree, that makes finding and distinguishing them quite easy and intuitive. A typical user only needs to know a few event types and where they are to be found in a hierarchical tree to perform his specialized job within the business.
c) The Financial Event Types are variable and can be defined by the particular business based upon its particular industry and its unique way of doing business.
d) The hierarchical tree in which the Financial Event Types are organized into is of a variable structure and can be defined by specifically for the particular user. The same business can have any number of hierarchical trees defined for its employee. An auto dealership can have a small tree defined for its car salesmen that allow them to only enter transactions for auto sales and trade-ins. This same business can have another tree defined for its parts department, containing only a small subset of all of the possible Financial Event Types, and it may have another tree defined for its accountants that is complete and has all of the Financial Event Types.
e) Financial Event Types may be defined for more dimensions than the dimensions of debit and credit. The financial transactions that credit the Cash account (dimension) and debit the Auto Repairs account (dimension) may be broken down by another dimension that defines the different companies that do the auto repairs, allowing analysts to measure the relative efficiency of various repair providers.
f) Financial Event Types are intuitive whereas debiting and crediting ledger accounts is technical work requiring specific and extensive skills. Most employees in most companies can easily grasp the idea of a “Cash Sale” or “Repairs Completed on Account,” particularly where most employees work with a small subset of categories of the company's transaction types.
g) The difficult burden of journaling business transactions can be done by employees who are not trained in accounting in accounting and the bookkeeping skills. A typical employee only needs to know a few Financial Event Types that are used for his specific job, freeing the accounting staff to do what they do best, preparing and analyzing business information entered by non-accounting staff.

### SUMMARY OF THE INVENTION

In accordance with the present invention, financial transactions can be entered into an accounting journal by people who don't understand the accounting concepts of debiting and crediting ledger accounts. All that they have to know is the type of the transaction, and by designating the type of transaction, the present invention will automatically debit and credit the correct accounts without further effort from the user.

The present invention is made up of three components:

1. A set of Financial Event Types, each Financial Event Type representing a type of financial activity in which the business becomes involved with and needs to be recorded in the accounting journal of the business; each Financial Event Type includes a mapping to a single ledger account to be debited by the transactions of that type and a mapping to a single ledger account to be credited by the transactions of that type;

2. A hierarchical tree data structure, referred to hereinafter as the Financial Event Tree, in which the leaves of the data structure are comprised of Financial Event Types, and in which the internal nodes of the data structure are categories of Financial Event Types which are used to make the Financial Event Types easy to understand and easier to locate;

3. A software engine, the Financial Event Software Engine, referred to hereinafter as the “engine” or the “software engine,” that creates the Financial Event Tree for the user and accepts the user's selection of a Financial Event Type and a transaction amount and records the transaction into an accounting journal as a debit to the selected Financial Event Types debit account and as a credit to the selected Financial Event Types credit account.

Each Financial Event Type contains a mapping to a particular account that is to be debited by a transaction of its type; a mapping to the particular account that is to be credited by a transaction of its type; and a short description that can be used as the default description to be entered into the journal. The combination of a particular account to be debited and a particular account to be credited defines a single Financial Event Type and the user's selection of a given Financial Event Type that summarizes a transaction defines the double-entry effect that the transaction will have on the company's financial state.

Using Financial Event Types, the user only needs to enter the account of the transaction (also its date if it is not the default current date) and the proper accounts are debited and credited automatically—the identity of the accounts to be debited and credited are defined by the particular Financial Event Type.

If we look at FIG. 2, we see the relationships of a Financial Event Type to the accounts in the general ledger. That figure shows two Financial Event Types, each one related to two accounts in the general ledger, one relation being its debit relation and another being its credit relation.

In FIG. 3, we see the tabular view of the same relationships that existed in FIG. 2. The table is similar to what would be found in a relational database or a spreadsheet application. Each horizontal row of the table represents a single Financial Event Type. The first column of the table holds the name of the Financial Event Type; the second column identifies which account is debited by a transaction of the Financial Event Type; the third column identifies which account is credited by a transaction of the Financial Event Type; and the fourth column contains a default description of a transaction of that type. FIGS. 2 and 3 illustrate the mapping that exists between a Financial Event Type and the accounts in the general ledger (or the automated equivalent of the traditional general ledger).

Financial Event Types, like the ledger accounts themselves, are defined by the user in such a manner as to best accommodate his company's unique way of doing business. The present invention begins its operation by reading in the user's set of Financial Event Types and checking the validity of its account mappings. The individual ledger accounts, as well as the ways in which those ledger accounts can be combined into a debit and credit transactional relationship, are specific to a particular business and therefore, they need to be defined by the individual user.

The challenge with the present invention is to make a potentially enormous number of Financial Event Types workable and comprehensible to the user and his employees. The key to making a large number of objects, such as Financial Event Types or computer files easy to use, is to organize all of the objects into a nested set of categories that group the objects according to attributes that they have in common, similarity of behavior, or some other form of relationship that is meaningful to the user. Interrelating objects by category and subcategory is best done through a hierarchical tree structure where each internal node of the hierarchical tree represents a meaningful grouping of the objects (in this case, the Financial Event Types) that are the descendents of the internal node

This hierarchical tree used to group and subgroup objects is precisely how files are organized in a modern computer's file system. Each file is a leaf node of a single tree that has the file system itself as a root of the tree and internal nodes that are the directories and subdirectories for organizing the files. The advantage of this tree-like organization for managing files probably goes unappreciated by the average computer user who typically only directly accesses a few files in a system with, perhaps, thousands of files on its hard disk. The few files that he access may be his current work product (e.g., a text document that he is writing or a spreadsheet file that he is analyzing). He finds these files easily from the many files that contain images, applications, and other packages of information because they are located at a meaningful location in the tree that is the computer's file system. The user knows where the files that he is working on can be found because they are typically in a directory that he has created or that has been created just for him and the types of files that he is working on.

In a similar manner, thousands of Financial Event Types can exist for the user's business, but each of his employees is able to easily find the few Financial Event Types that are related to his (the employee's) work because they are located at specific places in the Financial Event Tree. A user interface to the Software Engine can provide him conveniently with the tree's structure and give him access to the actual Financial Event Types that are located within the tree. Most individual users of the Software Engine are involved in a small subset of their company's activities and they are therefore only in need of a small number of Financial Event Types to record their transactions. The fact that these Financial Event Types are located at meaningful places within a tree's structure makes their effort at journaling their own transactions easy and comprehensible.

The present invention is not just the use of Financial Event Types and the Software Engine that uses them to journal accounting transactions: it is also the about the Software Engine's ability to structure a collection of Financial Event Types into a tree structure that gives them meaning and convenience. The Financial Event Types are organized into a Financial Event Tree that is necessary to make them a viable method of journaling accounting transactions.

Within the Financial Event Tree, the individual Financial Event Types can be categorized and subcategorized to any depth to assist the user. The structure of the Financial Event Tree is completely determined by the user and the Software Engine uses the user's specifications to build the tree and present it to the employee that is using it to enter transactions into the journal. The user is able to change his specifications at any time and is free to experiment with a number of specifications in determining which structure is most efficient for his uses.

The way that a Financial Event Tree is created, the individual Financial Event Types are necessarily the leaf nodes of the tree (the end of the tree's branches). They are, by definition, unable to have children nodes of their own. The internal nodes are simply the arbitrary categories that the Financial Event Types are organized into. The Financial Event Types that belong to a category exist in the tree as children of the internal node that represents that category. Each internal node can have as many children as the user wants and the children can be either Financial Event Types or nested categories (represented as lower level internal nodes). Beginning from the root node, the tree can reach to any desired depth, having categories and subcategories, until finally the leaf nodes (the actual Financial Event Types) are reached.

Typically, the specification of how the tree and its Financial Event Types should be organized is expressed in an XML file (XML files inherently describe data in a hierarchical tree structure). The Software Engine reads the user's XML file and constructs a Financial Event Tree from its specifications. It keeps this tree in its internal memory and makes it available to any user interface that has access to it. The user interface may be a standard graphical user interface or it may be a secured web page displayed in an internet browser. The specifics of the user interface are subject to change and are not a critical part of the present invention. The present invention, however, makes the tree and the Financial Event Types that are its leaf nodes available for any user interface that allows a user to provide input for the Software Engine's journaling processing.

The user of the present invention defines his company's ledger accounts and then organizes them into a set of Financial Event Types. He specifies these Financial Event Types and the ledger accounts that they update in an XML specification file. That file defines all of the Financial Event Types into a meaningful Financial Event Tree. At the beginning of its operation, the Software Engine reads the XML file, constructs the Financial Event Tree in its internal memory, loads one of its many Journal Writer Modules (see FIG. 7) that is adapted to the user's implementation of an accounting journal, and then waits for the user to begin entering financial transactions to be written to the journal.

The user enters a journal transaction by selecting its Financial Event Type from the hierarchical tree provided by the Software Engine. The user's user interface obtains the Financial Event Tree from the Software Engine and presents it to the user (see FIG. 5). The user goes through the tree and selects a relevant Financial Event Tree and is prompted for the amount and date of the transaction. Providing these details, the user submits the transaction to the Software Engine. The Software Engine obtains from the Financial Event Type the identities of the accounts to be debited and credited, converts the user's data to a true journal entry, and calls its Journal Writer Module where the journal entry is converted to SQL or some other form that is used by the user's implementation of the accounting journal. The Journal Writer Module performs the actual writing to the journal and the Software Engine prepares itself for further user input.

### BRIEF DESCRIPTION OF DRAWINGS

FIG. 1 is a simple static object diagram showing the relationships between a single programming object that represents a typical Financial Event Type and two programming objects that represent two different ledger accounts. One of the ledger accounts that the Financial Event Type is related to is the account to be debited by a transaction of that particular Financial Event Type. The other ledger account is to be credited by a transaction of the Financial Event Type. The following reference points are indicated in the diagram:

101. an object that represents a single Financial Event Type, in this case one that is entitled “Utility Bill Paid with Cash,” representing the expense generating transaction of paying a utility bill;

102. the account that is to be debited by a transaction of the Financial Event Type;

103. the account that is to be credited by a transaction of the Financial Event Type.

FIG. 2 illustrates the relationships that exist between Financial Event Types and ledger accounts. In particular, it shows how two Financial Event Types each have a debit relationship, shown by the black arrow and the reference 203, to a particular ledger account, and a credit relationship, shown by the dashed arrow and reference 204, to a second ledger account. All of the Financial Event Types are listed in the left-most column designated by reference 201, and all of the ledger accounts are listed in the right-most column designated by reference 202. The following reference points are indicated in the diagram:

201. a list of the Financial Event Types used by a business, listed by name in a single column;

202. a list of the ledger accounts used by a business, listed by name in a single column;

203. a solid line that represents the debit relationship between a single Financial Event Type and a particular ledger account; in this case it shows that transactions of the “Received Cash Rent” Financial Event Type cause the “Cash” account to become debited;

204. a dashed line that represents the credit relationship between a single Financial Event Type and a particular ledger account; in this case it shows that transactions of the “Received Cash Rent” Financial Event Type cause the “Rental Income” account to become credited.

FIG. 3 illustrates the relationships between Financial Event Types and ledger accounts in a tabular (“spreadsheet”) format. Each row in the figure represents a single Financial Event Type and each column represents a relationship that the Financial Event Type has in the present invention. The first column, referenced 301, contains the name of the Financial Event Type; the second column, referenced 302, contains the name of the ledger account that is to be debited by an event of the particular Financial Event Type; the third column, referenced 303, contains the name of the Financial Event Type's credit account; and the fourth column, referenced 304, contains the default description of the financial event (typically, a user would be able to change this in a user interface to optionally provide more specific information about the event). The following reference points are indicated in the diagram:

301. a column in the table that contains the name of each Financial Event Type;

302. a column in the table that contains the name of the account to be debited by transactions of the related Financial Event Type;

303. a column in the table that contains the name of the account to be credited by transactions of the related Financial Event Type;

304. a column in the table that contains the default transaction description of the transactions of the related Financial Event Type.

FIG. 4 shows a hierarchical tree of Financial Event Types. Here, following the user's specifications, the company's Financial Event Types are organized in a hierarchical tree that makes them easy to understand for the unskilled employee and easy to find for even the trained accountant. It is important to note in this figure the relationships that exist between the Financial Event Types and the higher level categories into which they are arranged in the hierarchical tree. In FIG. 4, the Financial Event Types are all leaves of the tree (the end-points of the various branches in the tree).They are represented by in the figure as labeled rectangles. The internal nodes of the tree (the non-leaf nodes) represent user-defined higher categories to which the various Financial Event Types are organized into for comprehension and ease-of-use. The internal nodes are represented as labeled ovals and they can be configured by the user into any number of branches and levels to assist the user's employees.

The relationships of the Financial Event Types in FIG. 4 to the higher-level categories that are represented by the internal nodes of the figure is directly analogous to the relationships that files have to their directories in the modern computer operating system. In a computer's operating system, the files are the real containers of information and they exist as leaf nodes in the hierarchical tree that is the computer's system of files and directories. Directories in the file system primarily serve the purpose of organizing thousands of files in such manner that the files are easy to find. Furthermore, the directories create groups of files where the files are logically related to each other. In the present invention, these same relationships exist between the Financial Event Types, which are the real payload of the invention Oust as the files are the real payload of the computer's file system), and the categories that are used to categories (analogous to directories) that are used to make the Financial Event Types easy to find and understand. The following reference points are indicated in the diagram:

401. an internal node representing a general category of Financial Event Types; this is configurable by the user as a way to make the Financial Event Types easy to find and understand;

402. a leaf node representing an actual Financial Event Type; this also is configurable by the user.

FIG. 5 illustrates the same hierarchical tree of Financial Event Types found in FIG. 4. The difference between the two figures is that, in FIG. 5 the Financial Event Types and the categories that they belong to are displayed as a hierarchical tree in the manner that such data structures are shown in a typical user interface. A typical user interface to the Software Engine will present the user with a hierarchical tree in a fashion such as the one shown in FIG. 5. When the user selects one of the Financial Event Types, shown as leaf nodes in the diagram (they are symbolized by “slips of paper” icons rather than the “file folders” icons in the diagram), he will probably receive a pop-up screen that is very similar to the one in FIG. 9 herein, showing the details of the Financial Event Types and prompting the user for simply the amount of the transaction to complete the journaling process.

FIG. 6 is a flowchart that shows how the present invention provides the user with the Financial Event Types and their categories. The figure references a user interface which is an optional part of this invention. Any number of user interfaces may be used with this invention, providing only that the user is able to access a display screen or device that allows him to select a Financial Event Type that describes the financial transaction and enter the amount of the transaction. The following reference points are indicated in the diagram:

601. the user begins the process by requesting a Financial Event Tree, probably in a user interface which he is using to journal accounting transactions by selecting a Financial Event Type of each transaction and adding the its amount;

602. the software engine reads in the user's specification for the Financial Event Tree; this specification includes all of the actual Financial Event Types and the ledger accounts that they are related to; it also expresses how the Financial Event Types are to be organized into a hierarchical tree of categories;

603. after the root of the hierarchical tree is created, it is required to create its children nodes; it does this with the first recursive call to the CreateChild subroutine;

604. after the call to the recursive CreateChild subroutine, the software engine has completed a Financial Event Tree and returns it to the user interface where the user is able to use it to journal accounting transactions;

605. the CreateChild subroutine begins its process;

606. if the node being created is an internal node (not a leaf node), a simple category internal node is created and then the processing moves on to produce this nodes children with another recursive call to the CreateChild routine for each child node;

607. if the node being created is a leaf node, a node is created without children and without any further calls to the CreateChild subroutine; this node contains the details of a true Financial Event Type, including the identities of the debit and credit accounts; this information is obtained from the user specifications;

608. for each child of the internal nodes created by the CreateChild subroutine another recursive call must be made to another instance of the CreateChild subroutine; this process continues down the tree until a leaf node is reached, at which point the processing in reference 607 is performed, beginning the return back up the tree as internal nodes run out of children nodes and the root node is eventually reached;

609. the CreateChild subroutine is complete even for an internal node; this happens when the internal node runs out of its own children nodes to process.

FIG. 7 is a flowchart that shows how the present invention receives a transaction of a given amount and Financial Event Type, and uses the information to update the relevant ledger accounts (or the accounting equivalent of ledger accounts). The user begins the process by selecting the Financial Event Type that is applicable to the transaction that is being recorded. This part is being done, presumably, through a typical user interface, perhaps even an internet browser. The Software Engine accepts the user's request for a Financial Event Type and provides an object that summarizes it. The user interface displays a summary of the Financial Event Type to the user and prompts him for the amount of the transaction (see FIG. 9). The user submits the transaction to the Software Engine where it is then entered into the accounting journal.

The actual writing to the accounting journal is done through a configurable plug-and-play module that is used as an adaptation to the user's particular implementation of the accounting journal. There are interchangeable “Journal Writer Modules” for SQL databases, etc., and the one that is used by the Software Engine is configured when the Software Engine begins its execution.

The following reference points are indicated in the diagram:

701. the user begins to journal an accounting transaction; the process starts by his selection of the relevant Financial Event Type;

702. the Software Engine returns to the user interface the details of the Financial Event Type so that the user interface can present the same to the user and prompt the user for the amount of the transaction;

703. the user inputs the amount of the transaction and the user interface passes the amount and the identity of the selected Financial Event Type to the Software Engine;

704. the software engine prepares to enter the transaction in the journal; at this point, the challenge for the software engine is how to make itself useful with many different implementations of an accounting journal; it does this through what is known in the software industry as the “strategy design pattern;” the strategy design pattern is a way of creating many implementations of the same software function, and, by giving them all the same call interface, they can be plugged-and-played according to which one of the many implementations fits the particular solution—in this case, which one meets the requirements of the type of accounting journal that is being used; if the journal is a standard relational database table, one version of the implementations will be used and if it is a standard text file, another might be used; at this point, the Software Engine calls the relevant implementation as a subroutine or module that is one of the many versions of that subroutine or module that is available to it; all of the various implementations are known as the “Journal Writing Module,” which are described in better detail in FIG. 10;

705. after the Journal Writing Module has returned after performing the actual writing of the transaction to the journal, the Software Engine returns control to the user interface and the user who is ready to input another transaction and begin the process over again;

FIG. 8 illustrates, in a tabular (“spreadsheet”) form, the relationships that exist between Financial Event Types and the ledger accounts that they affect. This figure is almost the same as FIG. 3 above; however, FIG. 8 shows how the Financial Event Types may be expanded to manage more dimensions of information than that is usually provided by the traditional accounting model. The present invention considers the debit relationship a single dimension of the transaction and the credit relationship as a second dimension. In addition to these two standard accounting dimensions, more dimensions can be provided that provide further ways of categorizing financial events. For example, Financial Event Types that describe income transactions may contain further information about the customer demographics or some other critical feature of the company's business. In FIG. 8, a dimension has been added to the Financial Event Types that track which rental units in a apartment renting company are related to income production and expense allocation. Many other dimensions can be added to the Financial Event Types which allow a business to track where and how it produces income for its managers and investors.

The following reference points are indicated in the diagram:

801. a column in the table that contains the name of each Financial Event Type;

802. a column in the table that contains the name of the account to be debited by transactions of the related Financial Event Type;

803. a column in the table that contains the name of the account to be credited by transactions of the related Financial Event Type;

804. a column in the table that contains the default transaction description of the transactions of the related Financial Event Type;

805. a column in the table that contains the identity of the rental unit (for a presumably leasing business) that is effected by the financial transactions being recorded in the journal.

FIG. 9 is an example of a user interface that presents a Financial Event Type to the user. Note that the accounts to be debited and credited are already determined. The user, having once selected this Financial Event Type, needs to only fill in the amount of the transaction to completely record the transaction.

FIG. 10 is a UML Static Structure diagram showing the relationship between the Software Engine, the user's Financial Event Tree specification, a typical user interface module presenting Financial Event Types to the user, and a typical Journal Writer module. Notice that the Journal Writer module that is being used in a selected implementation that matches a specified programming interface defined by the Journal Writer interface. This allows the Software Engine to configure itself with one of many possible implementations of the Journal Writer module. In particular, the Software Engine is able to configure itself with the particular Journal Writer Module that works with the particular user's implementation of the accounting journal.

Also note in FIG. 10, that the particular user interface is also a configurable option for the Software Engine, a typical interface allowing any number of possibilities for the particular user interface that is to be used to satisfy the user's needs.

FIG. 11 is an XML user's specification for a Financial Event Tree. Note that, like all XML documents, it defines a hierarchical tree of data. The root of the XML tree is the tag “FinancialEvents.” The leaf nodes of the tree are all tags entitled “FET” which is an acronym for “Financial Event Type”. These leaf nodes have the attributes that define a completed Financial Event Type:
the name of the Financial Event Type;
the name of the ledger account that is to be debited by a transaction of the type;
the name of the ledger account that is to be credited by a transaction of the type;

The other tags define categories that the Financial Event Types belong to. Together, all of the tags define a hierarchical tree that accommodates the behavior of the business.

### DETAILED DESCRIPTION OF PREFERRED EMBODIMENTS

The preferred embodiment of the present invention is made up of three components:

1. a set of event classifications that correspond to a debit/credit account combination in accounting; these objects are known as Financial Event Types;

2. a hierarchical tree data structure that contains a set of Financial Event Types as leaf nodes and any number of internal nodes that categorize Financial Event Types for convenience and comprehension; this hierarchical tree data structure is referred to herein as the Financial Event Tree;

3. a software program that constructs the Financial Event Tree from user specifications written in XML and records transactions in an accounting journal using a user's selection of a Financial Event Type and the date and amount of the transaction; this software program is referred to herein as the Financial Event Software Engine.

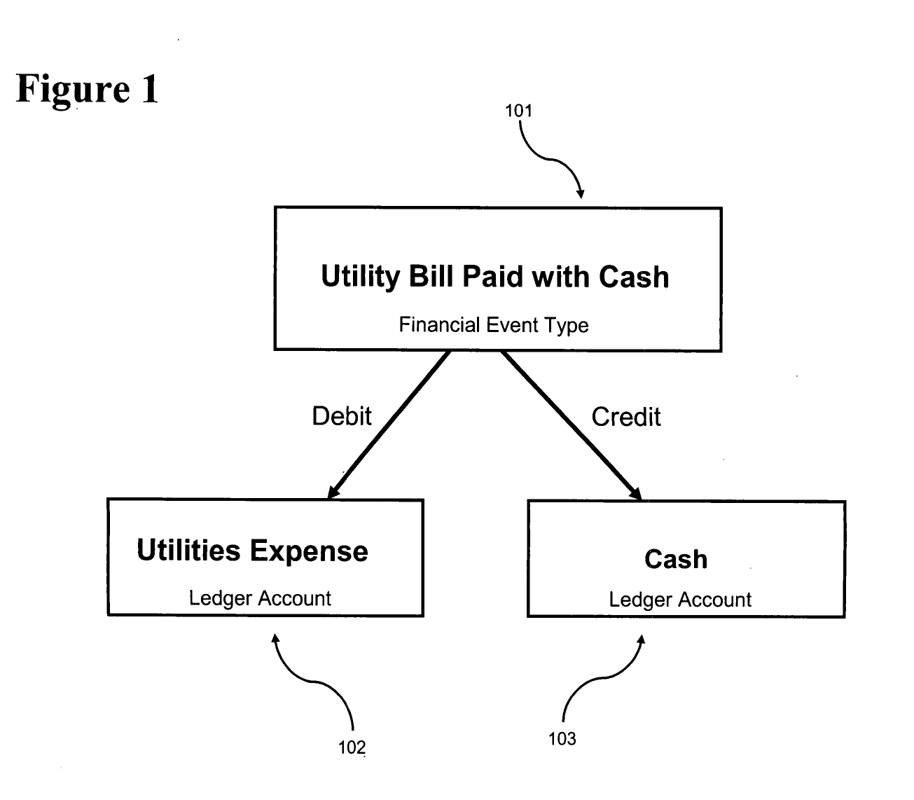

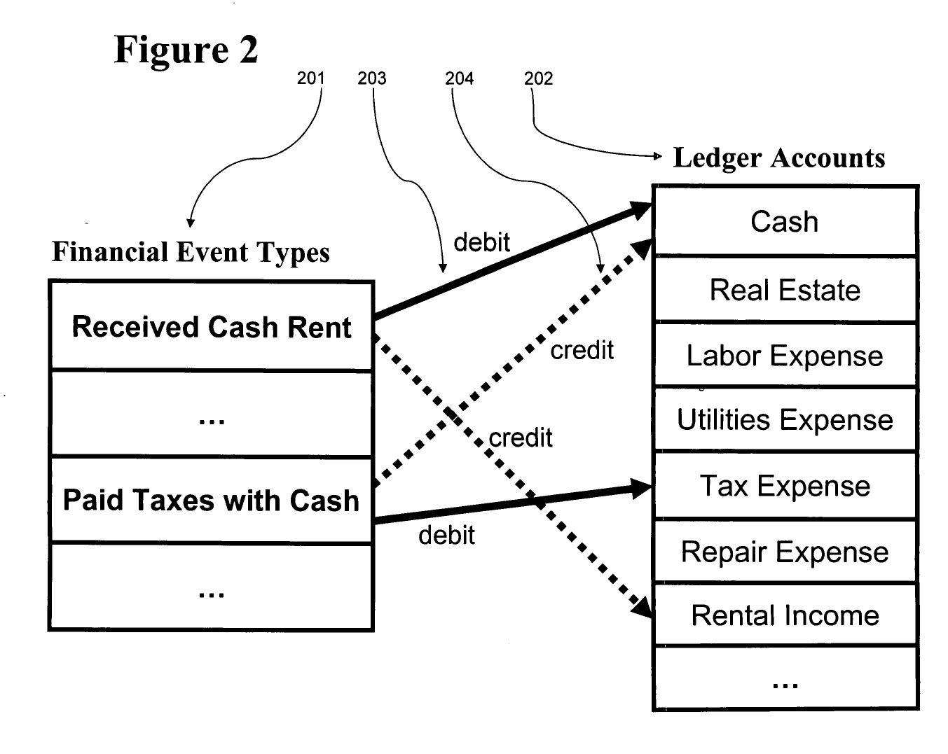

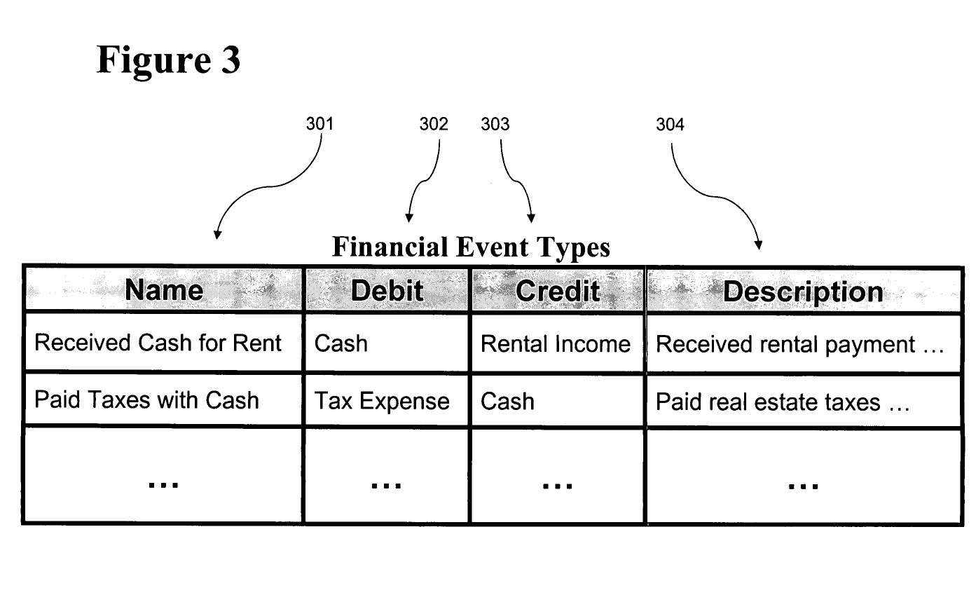

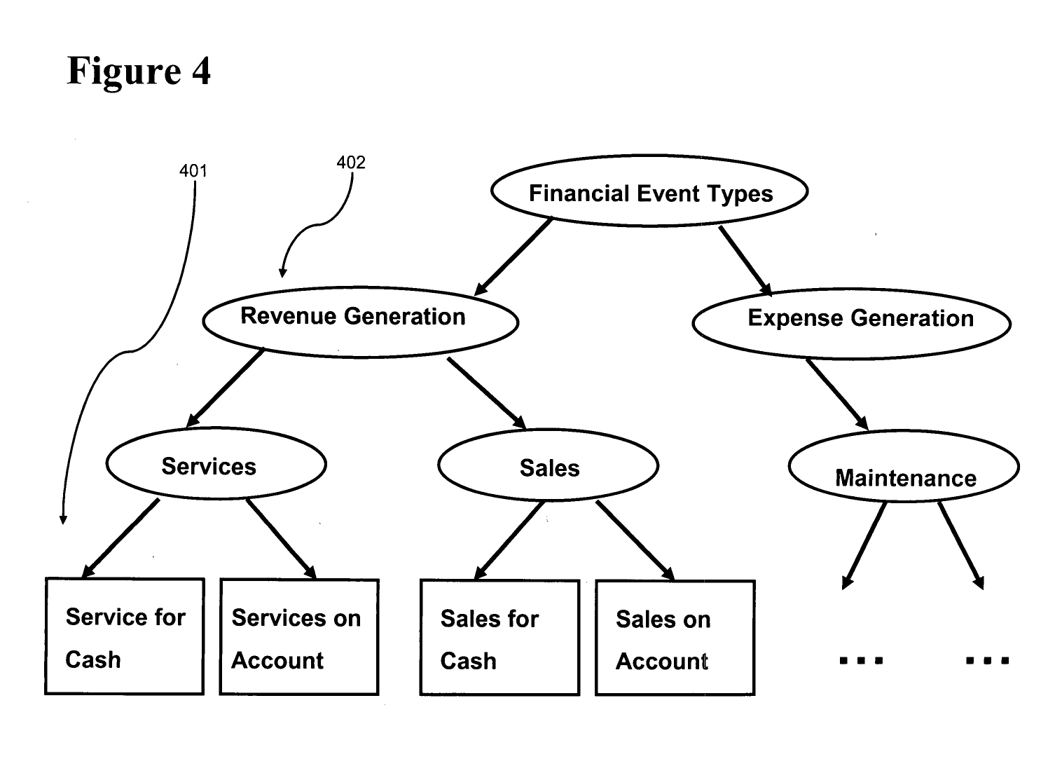

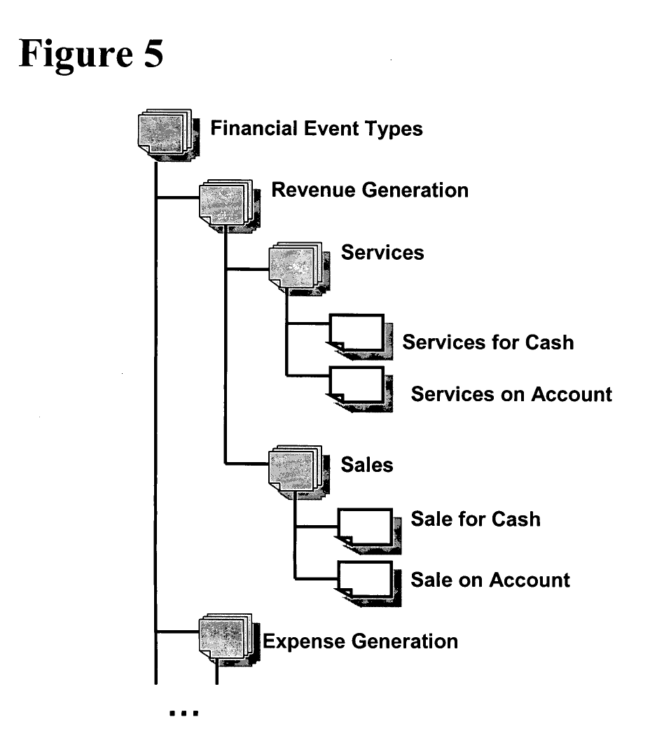

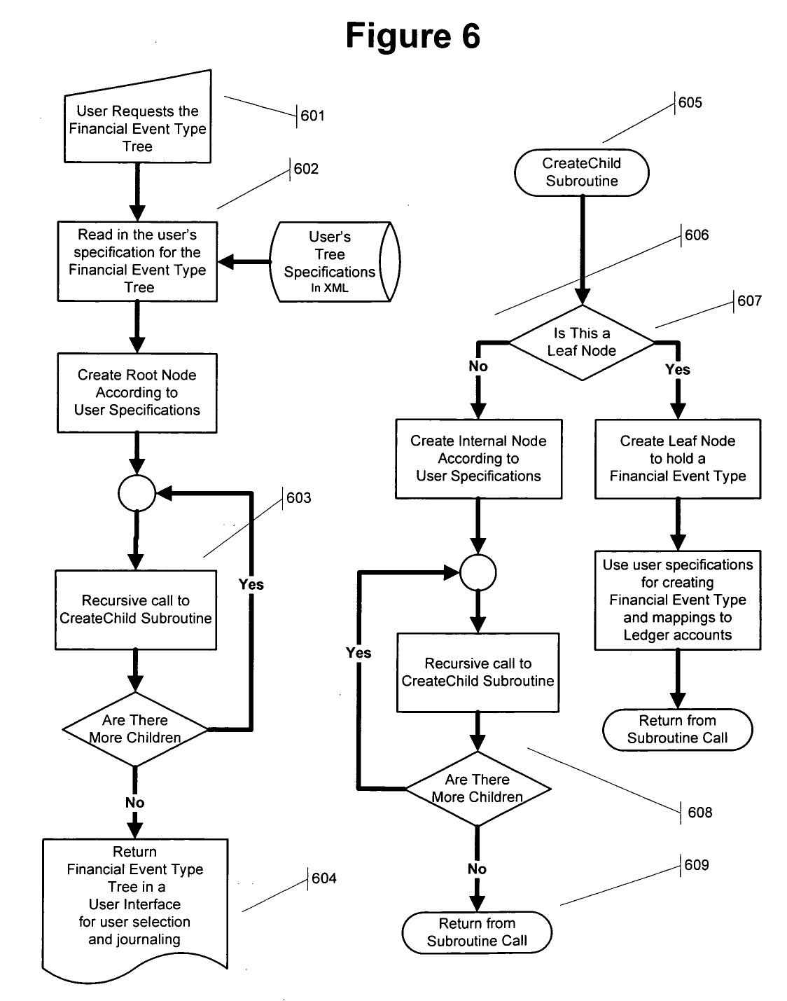

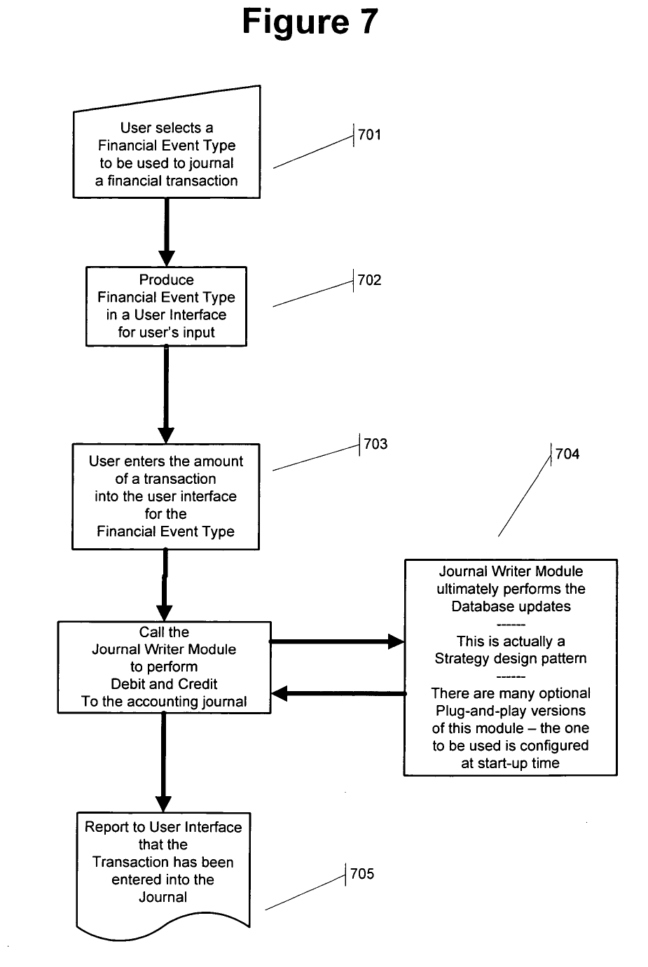

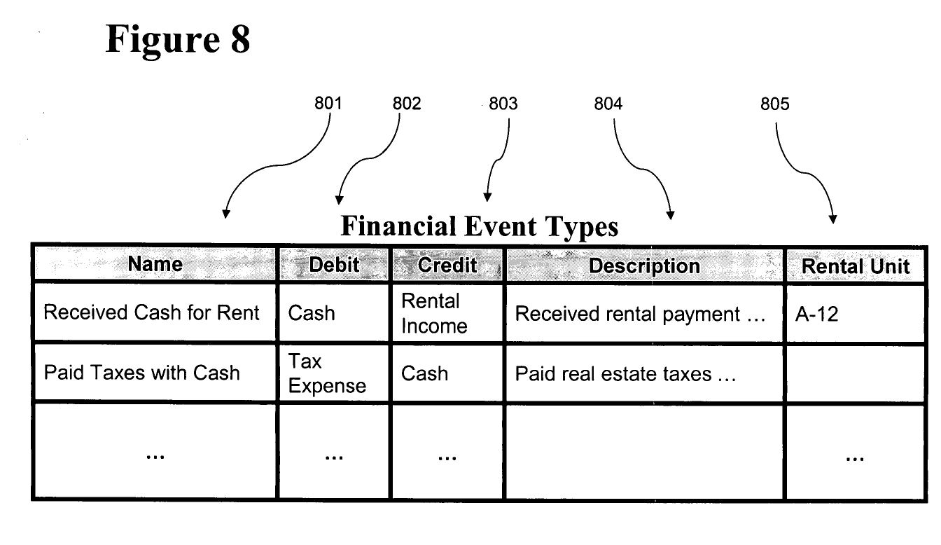

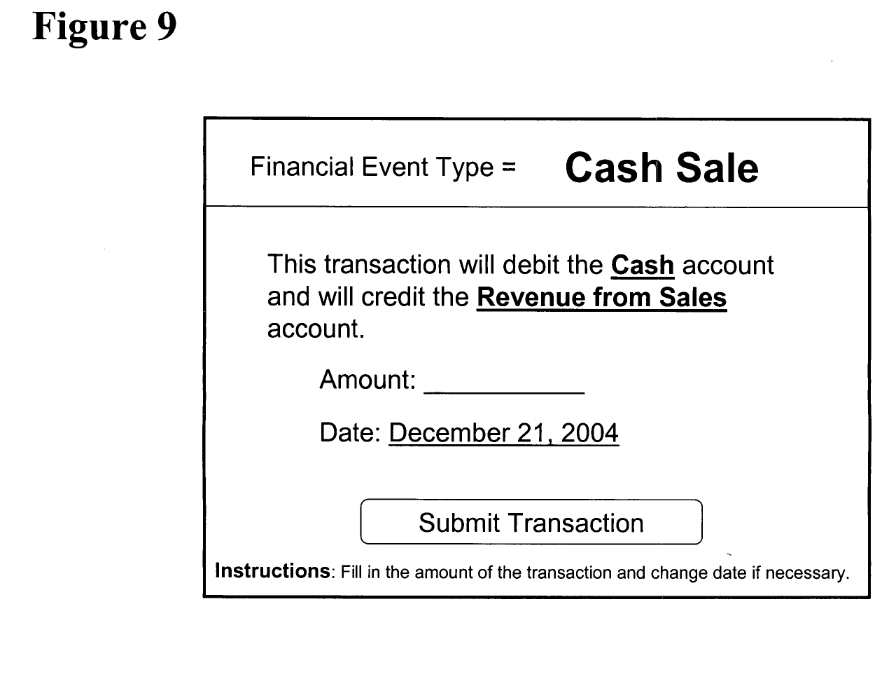

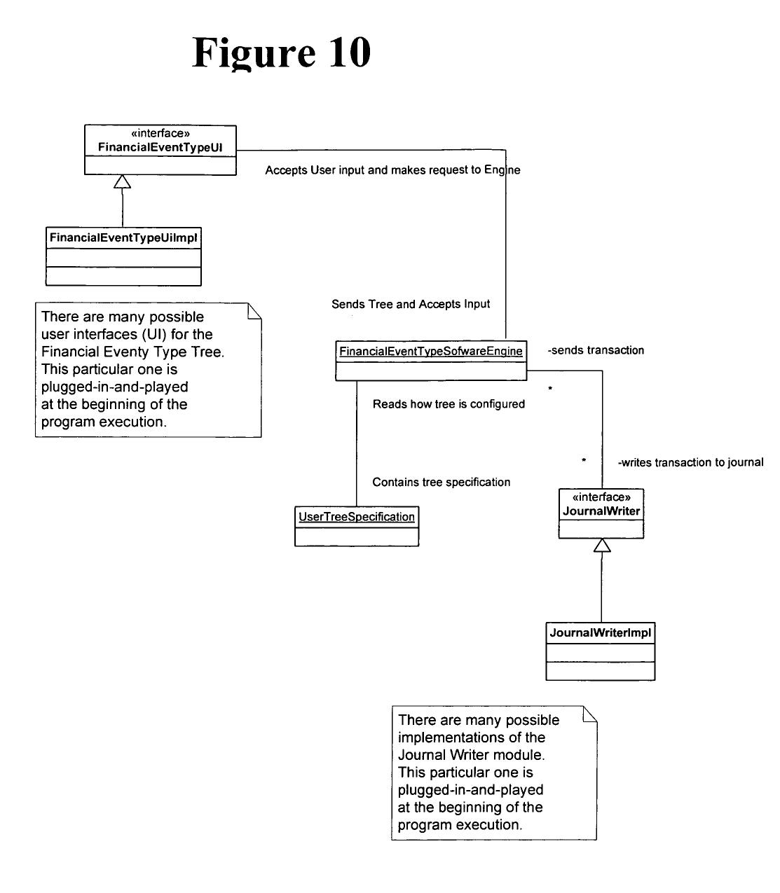

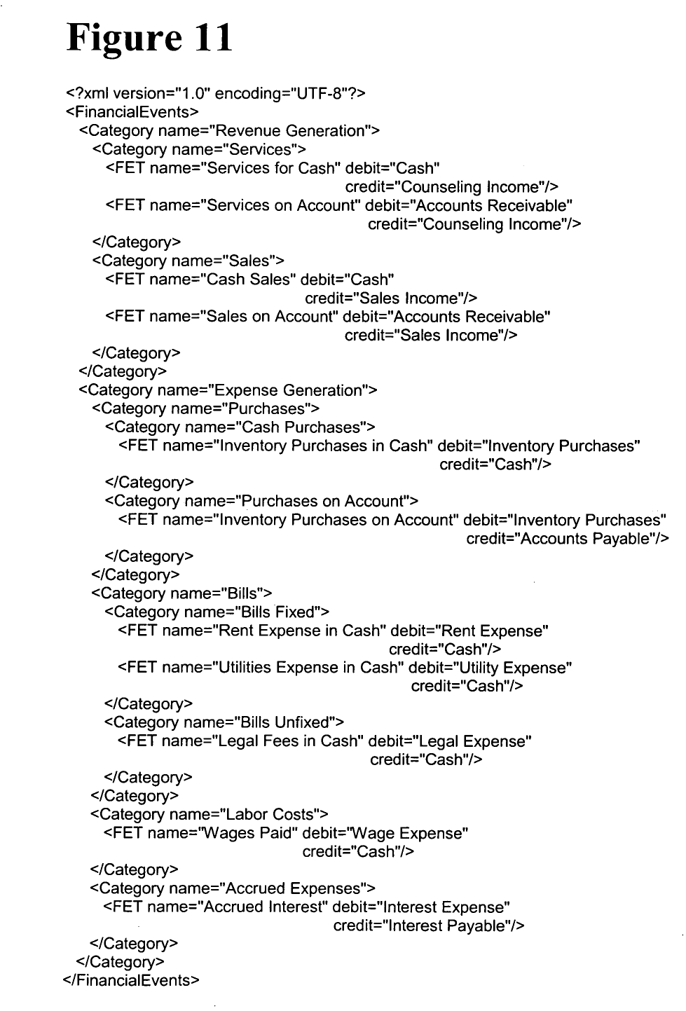

The preferred embodiment of the Financial Event Type is illustrated in FIGS. 1, 2, and 3 and the preferred embodiment of the Financial Event Tree is illustrated in FIGS. 4 and 5. The preferred embodiment of the Financial Event Software Engine is shown in the flow charts in FIGS. 6 and 7. A UML diagram of the Financial Event Software Engine is shown in FIG. 10.

If we look at FIG. 1 we see a simple relationship diagram showing the association of a single Financial Event Type with its two ledger accounts. One of the associations relates the Financial Event Type to a ledger account that is debited by transactions of the Financial Event Type; the other relates the Financial Event Type to a ledger account that is credited by transactions of the Financial Event Type. The user enters transactions in the journal by simply selecting a Financial Event Type and specifying the date and amount of the transaction—the software engine performs all of the remainder of the journaling task, including making the decision where to debit and where to credit. If the unskilled user does not understand accounting and the concepts of debit and credit, he can simply use the present invention to simplify the task.

When the software engine of the present invention begins its execution, it opens up an XML file that the user has created. The user's XML file contains the specifications on how the Financial Event Tree is to be constructed and contains the definitions of the Financial Event Types that serve as the leaves of that tree. FIG. 11 is an example of a simple XML specification for the present invention. Since XML files are, by definition, hierarchical tree data structures, the XML file in FIG. 11 is a tree of tags that correspond exactly to the nodes of the Financial Event Tree. Each tag in the XML file represents a node in the central data structure of the present invention. If we review that figure we see that the root of the tree is a tag that is simply known names “Financial Events”. This tag defines the root of the Financial Event Tree. Looking further we see that all of the leaf tags, corresponding to the leaf nodes of the Financial Event Tree, are labeled “FET,” indicating that they define an actual Financial Event Type, and that the internal tags, corresponding to the internal nodes of the Financial Event Tree, are all labeled “Category” and are used to group and subgroup the Financial Event Type in a meaningful fashion.

Both the Category and FET tags have names which correspond to the names that belong to the internal nodes and Financial Event Types. In addition to their names, the FET tags contain XML attributes that define which ledger accounts are to be debited and credited by transactions of the Financial Event Type. The XML file provides a complete definition of the Financial Event Tree that serves as the operational cornerstone of the present invention.

As the software engine continues to prepare itself for service to the user, it further configures itself by reading in the user's specifications for which Journal Writer Module works with his particular implementation of an accounting journal. If the journal is implemented in an SQL database, a Journal Writer Module for the SQL database is loaded into the software engine, along with the actual SQL statement that adds a transaction to the database. If the journal is implemented in a text file, a different Journal Writer Module is loaded into the software engine to perform the actual data update to the journal.

After configuring the Financial Event Tree according to the user's specifications and loading in the Journal Writer Module that works for the user, the software engine is ready to take user input for transaction recording. The user works with one of many possible user interfaces that can all access the Financial Event Software Engine. Perhaps through a GUI window or a secured internet web page, the user begins the process of recording a financial transaction by selecting an applicable Financial Event Type from a Financial Event Tree that appears to him much like the example in FIG. 5. FIG. 5 is a typical presentation of a hierarchical tree data structure in a user interface. By selecting the applicable Financial Event Type from the leaves of the tree of FIG. 5, the user has already performed much of the work of writing the transaction to the accounting journal.

After the Financial Event Type has been selected by the user from the Financial Event Tree, he is given a second user interface window that allows him to complete the details of the transaction. FIG. 9 is an example of a user interface that is sufficient for the user to complete the transaction. In FIG. 9, the user is actually given the details of the Financial Event Type, including the identity of the ledger accounts that are to be debited and credited. What is left for him to complete is primarily just the actual amount of the transaction. Optionally, the user can change the date (the computer should be able to determine the current date and provide it to him as a default). The user can also modify the default transaction description that is defined for the Financial Event Type. After updating the details of the transaction, the user begins the journaling process by submitting the details to the software engine.

The Software Engine of the present invention receives the user's data that represents a single financial transaction to be entered into an accounting journal. The data includes the Financial Event Type that the transaction belongs to and the date and amount of the transaction (optionally, a modified version of the description). From this a complete journal entry can be created. The software engine determines from the Financial Event Type the identity of the ledger accounts to be debited and credited, completing all of the information needed for the journal entry. It sends all of this information to the actual Journal Writer Module that it has configured itself with. It is in this Journal Writer Module where the actual SQL (or other update expression) is assembled from the user's data and the entry is made. The software engine reports the successful writing operation to the user and awaits another update cycle to occur. In effect, the present invention has successfully provided a tool to the user which allows him to perform a technically complex operation without any specific skill or training. The present invention has made the operation of recording a financial transaction to an accounting journal something any typical employee can do for his company.

From the description above, a number of advantages of the Financial Event Software Engine become evident:

a. The need for the user to know how to directly debit and credit ledger accounts is eliminated by the present invention. The user enters a transaction in the journal by simply selecting a Financial Event Type that describes the transaction and entering the date and the amount of the transaction (in a user interface the date will typically default to the current date). The software engine actually performs the journal update and thereby is responsible for actually debiting and crediting of the ledger accounts.

b. The typical user of the software engine only needs to know a few of the Financial Event Types and where they exist in the Financial Event Tree to perform his part of the company's accounting duties. This is a simple job because the Financial Event Types can be located at meaningful places in the Financial Event Tree.

c. Each business has its own set of ledger accounts and can define them to fit its own industry and way of doing business. In the same manner, the business that uses the present invention is able to specify the Financial Event Types that relate its ledger accounts. It is also able to specify the structure of the Financial Event Tree in such a manner as to be meaningful to its employees and easy for them to use. Like the ledger accounts themselves, this invention can be configured to match the needs and conveniences of the business that it is serving.

d. The present invention makes the task of entering financial transactions into an accounting journal something that can be done by the unskilled employee, freeing the labor of the skilled accountants to monitor the journal for accuracy and producing and analyzing the financial statements that ultimately get their data from the journal.

Having thus described the invention in rather full detail, it will be understood that such detail need not be strictly adhered to, but that additional changes and modifications may suggest themselves to one skilled in the art, all falling within the scope of this invention as defined by the subjoined claims.

What is claimed is:

1. A software machine, hereinafter referred to as the software engine, comprising:
a. a memory which is able to store a hierarchical tree data structure;
b. the ability to receive requests from various user interface devices;
c. the ability to read and write data between its own memory and a hard disk or other permanent memory device;
d. said software engine creating and maintaining data structures, hereinafter referred to as financial event types, that each represent a category of financial transactions and map said financial transactions to a ledger account to be debited by said financial transactions and a ledger account to be credited by said financial transaction;
e. said software engine receiving the description of a financial transaction, said description including the amount and date of a said financial transaction and the identity of the said financial event type to which it belongs, and said engine recording said financial transaction within an accounting journal;
f. said software engine creating and maintaining a hierarchical tree data structure, hereinafter referred to as a financial event tree, that contains as its leaf nodes the said financial event types and contains as its internal nodes categories and subcategories of said financial event types, said financial event tree being constructed according to the specifications of the business;
g. said software engine creating and maintaining said financial event tree by reading in the user's specifications for said financial event tree and producing the said internal nodes and the said leaf nodes according to those specifications;
h. said software engine producing for the said financial event tree for the user in variable user interfaces that allow the user to select a financial event type from the said financial event tree in order to enter the record of a financial transaction into an accounting journal.

2. A software machine, referred to hereinafter as the software engine, as recited by claim 1, where said software engine writes the record of financial transactions into an accounting journal of the user's implementation using the financial event types that it creates and maintains as recited in claim 1.
